(19) United States
(12) Patent Application Publication
(10) Pub. No.: US 2010/0158513 A1
(43) Pub. Date: Jun. 24, 2010

(54) APPARATUS AND METHOD FOR MEASURING SIGNAL PERFORMANCE AND APPARATUS FOR SELECTING SIGNAL

(76) Inventors: Eui-suk Jung, Daejeon-si (KR); Jea-hoon Yu, Daejeon-si (KR); Byoung-whi Kim, Daejeon-si (KR); Jai-sang Koh, Daejeon-si (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/581,796

(22) Filed: Oct. 19, 2009

(30) Foreign Application Priority Data
Dec. 22, 2008 (KR) 10-2008-0131432

(51) Int. Cl. H04B 10/08; H04J 14/02

(52) U.S. Cl. 398/9; 398/79

(57) ABSTRACT

Provided are an apparatus and method for measuring signal performance and an apparatus for selecting a signal. The apparatus includes a wavelength selector selecting a signal having a specific wavelength from an input signal, a time selector selecting a signal input at a specific time from the selected signal having the specific wavelength, and a performance measurer measuring signal performance for the signal of the specific wavelength that is input at the specific time and selected by the time selector. Thus, it is possible to measure signal quality of each wavelength-division multiplexing (WDM)-time-division multiplexing (TDM) channel in a WDM-TDM hybrid environment.

### CROSS-REFERENCE TO RELATED APPLICATION

This application claims the benefit under 35 U.S.C. §119(a) of Korean Patent Application No. 10-2008-0131432, filed on Dec. 22, 2008, the disclosure of which is incorporated by reference in its entirety for all purposes.

### BACKGROUND

1. Field

The following description relates to an optical transmission system, and more particularly to an apparatus and method for measuring signal performance and an apparatus for selecting a signal in a wavelength-division multiplexing (WDM)-time-division multiplexing (TDM) hybrid system.

2. Description of the Related Art

Conventional optical line performance measurement in a wavelength-division multiplexing (WDM) system is different from that in a time-division multiplexing (TDM) system.

In a TDM system, an operation, administration and maintenance (OAM) packet data unit (PDU) is inserted, and a bit error rate (BER) is measured using a specific pattern. In a WDM system, a variable wavelength optical filter, demultiplexer, etc., is installed ahead of a component for measuring optical line performance, such as radio frequency (RF)-tone, polarization-nulling, sampling, equalizing, and correlation, so that optical line performance can be measured according to wavelength.

According to the conventional art, signal performance of only one of a WDM system and a TDM system can be measured. However, with the development of technology, research and development on networks in which a WDM technique and a TDM technique are used together have begun. For the research and development, technology for measuring performance for a hybrid signal according to the WDM technique and the TDM technique is needed.

### SUMMARY

The following description relates to an apparatus and method for measuring performance of each wavelength-division multiplexing (WDM)-time-division multiplexing (TDM) channel online in a WDM-TDM hybrid environment.

In one general aspect, there is provided an apparatus for measuring signal performance, including: a wavelength selector selecting a signal having a specific wavelength from an input signal; a time selector selecting a signal input at a specific time from the selected signal having the specific wavelength; and a performance measurer measuring signal performance for the signal of the specific wavelength that is input at the specific time and selected by the time selector.

The time selector may include a buffer storing the selected signal having the specific wavelength in order of time and a signal extractor selecting signal data stored at a specific position in the buffer from among signal data stored in the buffer to be provided to the performance measurer.

The apparatus may further include: a photoelectric converter converting the signal having the specific wavelength into an electrical signal; and a digital converter converting the electrical signal into a digital signal and providing the digital signal to the time selector.

In another general aspect, there is provided a method of measuring signal performance, including: selecting a signal having a specific wavelength from an input signal; selecting a signal input at a specific time from the selected signal having the specific wavelength; and measuring performance for the selected signal of the specific wavelength input at the specific time.

The selecting of the signal input at the specific time may include: storing the signal having the specific wavelength in order of time; and extracting a part of signal data input at the specific time from the signal data stored in order of time.

The method may further include, after the selecting of the signal having the specific wavelength, converting the selected signal having the specific wavelength into an electrical signal; and converting the electrical signal into a digital signal.

In still another general aspect, there is provided an apparatus for selecting a signal, including: a wavelength selector selecting a signal having a specific wavelength from a wavelength-division multiplexing (WDM)-time-division multiplexing (TDM) hybrid signal; and a time selector selecting a signal input at a specific time from the selected signal having the specific wavelength.

Other objects, features and advantages will be apparent from the following description, is the drawings, and the claims.

### BRIEF DESCRIPTION OF THE DRAWINGS

FIG. 1 illustrates a wavelength-division multiplexing (WDM)-time-division multiplexing (TDM) hybrid signal according to an exemplary embodiment.

FIG. 2 is block diagram of a network system including an apparatus for measuring signal performance according to an exemplary embodiment.

FIG. 3 is a block diagram of an apparatus for measuring signal performance according to an exemplary embodiment.

FIG. 4 illustrates a flowchart illustrating a method of measuring signal performance according to an exemplary embodiment.

Elements, features, and structures are denoted by the same reference numerals throughout the drawings and the detailed description, and the size and proportions of some elements may be exaggerated in the drawings for clarity and convenience.

### DETAILED DESCRIPTION

The detailed description is provided to assist the reader in gaining a comprehensive understanding of the methods, apparatuses and/or systems described herein. Various changes, modifications, and equivalents of the systems, apparatuses, and/or methods described herein will likely suggest themselves to those of ordinary skill in the art. Also, descriptions of well-known functions and constructions are omitted to increase clarity and conciseness.

FIG. 1 illustrates a wavelength-division multiplexing (WDM)-time-division multiplexing (TDM) hybrid signal according to an exemplary embodiment. According to conventional art, one wavelength is selected in a WDM situation, and signal performance for only the wavelength is measured. In FIG. 1, performance for an entire signal having a wavelength of λₙ is measured. In a WDM-TDM hybrid environment according to an exemplary embodiment, a signal input from another user may also be included in a signal having one wavelength according to a signal input time. Thus, a signal having a specific wavelength is further separated according to time to measure performance so that line performance of all users can be measured in the WDM-TDM hybrid environment. For example, signal performance of a part corresponding to λₙ-T₃ can be measured.

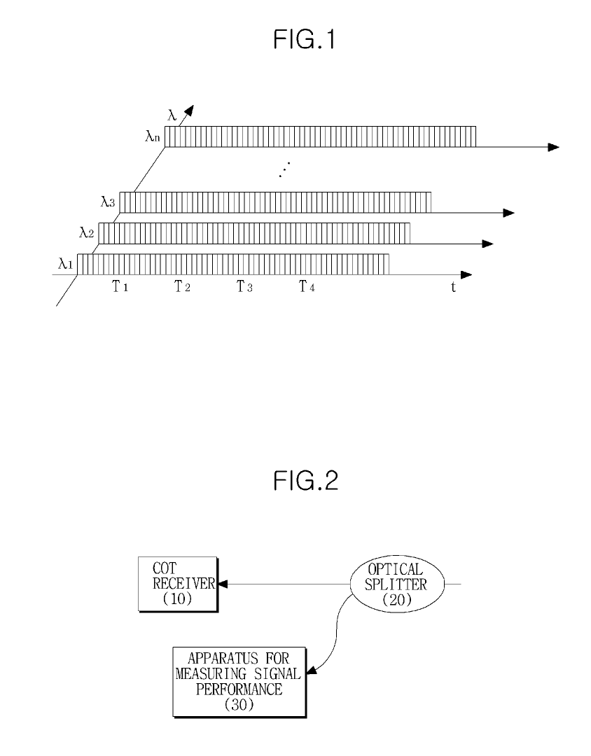

FIG. 2 is block diagram of a network system including an apparatus 30 for measuring signal performance according to an exemplary embodiment. In this exemplary embodiment, the apparatus 30 for measuring signal performance receives a signal that is input to a receiver 10 of a central office terminal (COT) and split by an optical splitter 20, as illustrated in FIG. 2. In this exemplary embodiment, the apparatus 30 for measuring signal performance selects a WDM-TDM channel using the optical signal split from a signal input to the COT receiver 10, and measures performance of the selected channel.

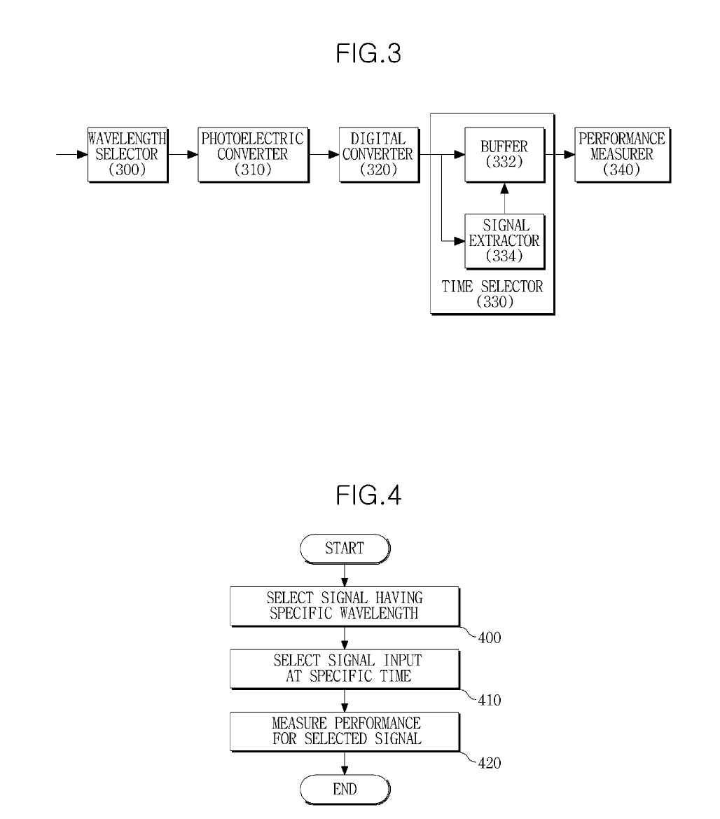

FIG. 3 is a block diagram of an apparatus for measuring signal performance according to an exemplary embodiment.

The apparatus for measuring signal performance according to an exemplary embodiment includes a wavelength selector 300, a photoelectric converter 310, a digital converter 320, a time selector 330, and a performance measurer 340.

An optical signal split by an optical splitter is input to the wavelength selector 300. The wavelength selector 300 splits a WDM-TDM hybrid signal according to wavelength, and selects a signal having a specific wavelength. In this exemplary embodiment, the wavelength selector 300 may include a variable wavelength optical filter. Also, the wavelength selector 300 may include a demultiplexer for demultiplexing and splitting a wavelength-division multiplexed signal according to wavelength.

The photoelectric converter 310 converts the signal of the wavelength selected by the wavelength selector 300 into an electrical signal. And, the digital converter 320 samples the electrical signal converted by the photoelectric converter 310 and converts it into a digital signal.

The time selector 330 extracts a signal input at a specific time from the signal of the wavelength selected by the wavelength selector 300. In this exemplary embodiment, the time selector 330 includes a buffer 332 and a signal extractor 334.

The buffer 332 stores signals that are sampled as digital signals from the selected signal of the wavelength through the photoelectric converter 310 and the digital converter 320, in order of time. In this exemplary embodiment, the buffer 332 is implemented by a first-in first-out (FIFO) buffer from which data input first is output first.

The signal extractor 334 causes signal data that is stored at a specific position in the buffer 332 among signal data stored in the buffer 332 in order of time, to be provided to the performance measurer 340.

In this exemplary embodiment, the signal extractor 334 receives the digital signal from the digital converter 320. And, the signal extractor 334 may extract information such as a signal transmission location and a signal length from the input signal. In this exemplary embodiment, the signal extractor 334 may extract such information by obtaining an operation, administration and maintenance (OAM) packet data unit (PDU) included in the digital signal. However, exemplary embodiments are not limited by the OAM PDU. Based on the obtained signal transmission location information and signal length information, the signal extractor 334 controls signal data stored at a specific position in the buffer 332 among data stored in the buffer 332 to be provided to the performance measurer 340.

In this exemplary embodiment, the signal extractor 334 may be implemented to select the corresponding data in order of time and measure performance for all time-division signals, or to measure performance for a time-division signal that is input from outside and corresponds to a specific time.

Under the control of the signal extractor 334, the performance measurer 340 monitors performance for a signal of a specific wavelength that is stored at a specific position in the buffer 332 and input at a specific time. In this exemplary embodiment, monitoring performance may include obtaining a bit error rate (BER) based on OAM PDU information included in signal data. However, exemplary embodiments are not limited by the OAM PDU information, and the performance measurer 340 according to an exemplary embodiment may measure performance of a signal and line according to a variety of methods and references.

Meanwhile, an apparatus for selecting a signal according to an exemplary embodiment includes a wavelength selector 300 and a time selector 330, and selects a signal that has a specific wavelength and input at a specific time from an input WDM-TDM hybrid signal. In this exemplary embodiment, the components of the apparatus for selecting a signal may be implemented by the same as those included in the above-described apparatus for measuring signal performance.

The wavelength selector 300 splits a WDM-TDM hybrid signal according to wavelength, and selects a signal having a specific wavelength. In this exemplary embodiment, the wavelength selector may include a variable wavelength optical filter. Also, the wavelength selector may include a demultiplexer for demultiplexing and splitting a wavelength-division multiplexed signal according to wavelength.

The time selector 330 extracts a signal input at a specific time from the signal of the wavelength selected by the wavelength selector 300. In this exemplary embodiment, the time selector includes a buffer 332 and a signal extractor 334.

The buffer 332 stores signals that are sampled as digital signals from the selected signal of the wavelength through a photoelectric converter 310 and a digital converter 320, in order of time. In this exemplary embodiment, the buffer 332 is implemented by a FIFO buffer from which data input first is output first.

The signal extractor 334 may select data input at a specific time by selecting signal data stored at a specific position in the buffer 332 from among signal data stored in the buffer 332 in order of time. In this exemplary embodiment, the signal extractor 334 may obtain information about a signal transmission location and a signal length from the signal of the specific wavelength selected by the wavelength selector 300. Based on the obtained information, the signal extractor 334 may select data input at a specific time.

FIG. 4 illustrates a flowchart illustrating a method of measuring signal performance according to an exemplary embodiment.

First, a signal having a specific wavelength is selected from an input WDM-TDM hybrid signal (operation 400).

The selected optical signal having the specific wavelength is converted into an electrical signal, sampled, and converted into a digital signal. Subsequently, a signal input at a specific time is selected from the digital signal converted from the selected signal having the specific wavelength (operation 410).

At this time, the digital signal is stored in order of time, and a part of the signal corresponding to a specific position is extracted, thereby selecting the signal input at the specific time. Here, signal transmission location information and signal length information is obtained based on the digital signal, and the part of the signal corresponding to the specific position is extracted according to the obtained information.

Then, performance for the selected signal that has the specific wavelength and is input at the specific time is measured (operation 420). In this exemplary embodiment, monitoring performance may include obtaining a BER based on OAM PDU information included in signal data. However, exemplary embodiments are not limited by the OAM PDU information, and may include measuring performance of a signal and line according to a variety of methods and references.

The present invention can be implemented as computer readable codes in a computer readable record medium. The computer readable record medium includes all types of record media in which computer readable data are stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

As apparent from the above description, signal quality of each WDM-TDM channel can be measured in a WDM-TDM hybrid environment. The environment is not limited to one type, and it is possible to classify channels and measure performance according to two methods (WDM and TDM) so that channel-specific performance can be easily measured and managed.

It will be apparent to those of ordinary skill in the art that various modifications can be made to the exemplary embodiments of the invention described above. However, as long as modifications fall within the scope of the appended claims and their equivalents, they should not be misconstrued as a departure from the scope of the invention itself.

What is claimed is:

1. An apparatus for measuring signal performance, comprising:
a wavelength selector selecting a signal having a specific wavelength from an input signal;
a time selector selecting a signal input at a specific time from the selected signal having the specific wavelength; and
a performance measurer measuring signal performance for the signal of the specific wavelength that is input at the specific time and selected by the time selector.

2. The apparatus of claim 1, wherein the time selector includes:
a buffer storing the selected signal having the specific wavelength in order of time; and
a signal extractor selecting signal data stored at a specific position in the buffer from among signal data stored in the buffer to be provided to the performance measurer.

3. The apparatus of claim 2, further comprising:
a photoelectric converter converting the signal having the specific wavelength into an electrical signal; and
a digital converter converting the electrical signal into a digital signal and providing the digital signal to the time selector.

4. The apparatus of claim 2, wherein the signal extractor obtains information about a transmission location of the input signal from the selected signal having the specific wavelength.

5. The apparatus of claim 2, wherein the signal extractor obtains information about an entire signal length from the selected signal having the specific wavelength.

6. The apparatus of claim 2, wherein the buffer is a first-in first-out (FIFO) buffer from which data input first is output first.

7. The apparatus of claim 1, wherein the wavelength selector includes a variable wavelength optical filter.

8. The apparatus of claim 1, wherein the wavelength selector includes a demultiplexer splitting a wavelength-division multiplexed signal according to wavelength.

9. A method of measuring signal performance, comprising:
selecting a signal having a specific wavelength from an input signal;
selecting a signal input at a specific time from the selected signal having the specific wavelength; and
measuring performance for the selected signal of the specific wavelength input at the specific time.

10. The method of claim 9, wherein the selecting of the signal input at the specific time includes:
storing the signal having the specific wavelength in order of time; and
extracting a part of signal data input at the specific time from the signal data stored in order of time.

11. The method of claim 9, further comprising, after the selecting of the signal having the specific wavelength:
converting the selected signal having the specific wavelength into an electrical signal; and
converting the electrical signal into a digital signal.

12. The method of claim 11, wherein the selecting of the signal input at the specific time includes obtaining information about a transmission location of the input signal from the digital signal and selecting the signal input at the specific time.

13. The method of claim 11, wherein the selecting of the signal input at the specific time includes obtaining information about an entire input signal length from the digital signal and selecting the signal input at the specific time.

14. An apparatus for selecting a signal, comprising:
a wavelength selector selecting a signal having a specific wavelength from a wavelength-division multiplexing (WDM)-time-division multiplexing (TDM) hybrid signal; and
a time selector selecting a signal input at a specific time from the selected signal having the specific wavelength.

15. The apparatus of claim 14, wherein the time selector includes:
a buffer storing the selected signal having the specific wavelength in order of time; and
a signal extractor selecting signal data stored at a specific position in the buffer from among signal data stored in the buffer to be provided to a performance measurer.
